(19) United States
(12) Patent Application Publication
(10) Pub. No.: US 2007/0285396 A1
(43) Pub. Date: Dec. 13, 2007

(54) Electric circuit structure of a question-and-answer alarm clock

(76) Inventor: Jing-Ping Fu, Taipei City (TW)

Correspondence Address: BACON & THOMAS, PLLC, 625 SLATERS LANE, FOURTH FLOOR, ALEXANDRIA, VA, 22314, US

(21) Appl. No.: 11/447,846

(22) Filed: Jun. 7, 2006

(51) Int. Cl. G06F 3/02; G09G 5/00

(52) U.S. Cl. 345/169

(57) ABSTRACT

An electric circuit structure of a question-and answer alarm clock includes an interface used as a transmitting interface for each unit, a display unit electrically interlocked onto the interface to show time and a question, an input unit electrically interlocked onto the interface, putting data in through an input device and showing the result via the display unit, a clock count unit electrically interlocked onto the interface and used to count the time, set the bell, and show the result by the display unit, a calculating unit electrically interlocked onto the interface and automatically generating a question when the bell rings, and showing the question by the display unit, and a control unit electrically interlocked onto the interface to access each unit. The display unit shows the question when the bell rings. The bell can be turned off only by inputting the correct answer.

### FIELD OF THE INVENTION

The present invention relates to an electrical circuit structure of a question-and-answer alarm clock and particularly to the circuit structure which automatically generate a question at random by computing the circuit. Accessing an internal control circuit, it will show a question. The question will be acknowledged by human brains and eyes sighted. If the correct answer is input, the bell can be really turned off.

### BACKGROUND OF THE INVENTION

As we know that the bell of a traditional alarm clock (either hand or digital clock) is turned on after the time set. When the time is up, the bell rings. Then the sleeper might turn the bell off and sleep again. Such device loses the real purpose of awakening. To solve the defect, we design a simple, interactive, and low cost alarm circuit structure. The sleeper has to input the right password generating through random computing to turn the bell off and be awakened. The concept of the password alarm clock is quite original and the similarity could not be found in the market.

### SUMMARY OF THE INVENTION

The invention is an electric circuit structure of a question-and answer alarm clock including an interface which is to be used as a transmitting interface for each unit, a display unit which is to be electrically interlocked onto the interface to show time and a question, an input unit which is to be electrically interlocked onto the interface, putting data in through an input device and showing the result via the display unit, a clock count unit which is to be electrically interlocked onto the interface and used to count the time, set the bell, and show the result by the display unit, a calculating unit which is to be electrically interlocked onto the interface and automatically generates a question when the bell rings, and shows question by the display unit, and a control unit which is to be electrically interlocked onto the interface to access each unit. The display unit will show a question when the bell rings. When inputting the correct answer, the bell can be turned off such that the goal to exactly awaken the sleeper can be achieved.

For a preferred embodiment, the display unit could be an LCD screen to show time and questions.

For another preferred embodiment, the display unit could be an LED screen to show time and questions.

For yet another preferred embodiment, the input device could be a keyboard.

### BRIEF DESCRIPTION OF THE DRAWINGS

FIG. 1 is a 3D outward appearance schematic drawing of a conventional alarm clock.

FIG. 2 is a 3D outward appearance schematic drawing of the present invention.

FIG. 3 illustrates an electric circuit structure schematic drawing of the present invention.

### DETAILED DESCRIPTION OF THE PREFERRED EMBODIMENTS

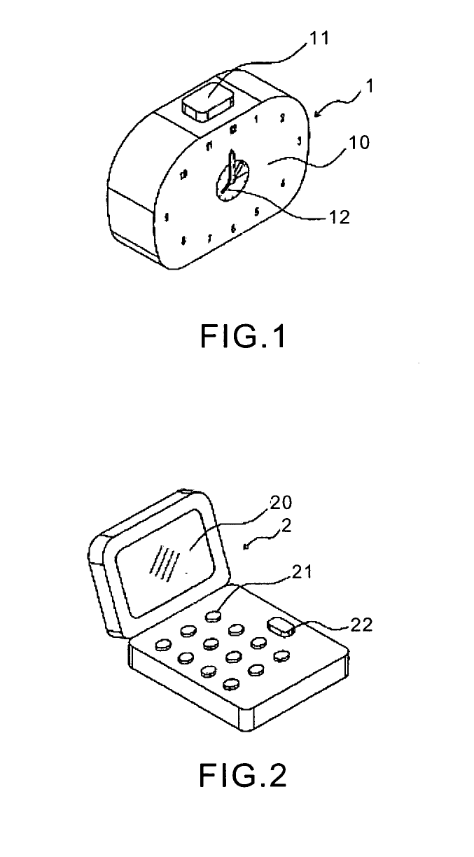

Please refer to FIG. 1 which shows a three-dimensional outward appearance schematic drawing of a conventional alarm clock. The conventional bell 1 could be unclosed via hand 12 set and the switch of the bell control button 11 on. When the time is up, the bell 1 rings. The user can just push the bell control button 11 to turn off the bell 1.

Please refer to FIG. 2 which shows a three-dimensional outward appearance schematic drawing of the present invention. FIG.2 is only one of various appearances of a question-and-answer alarm clock 2 of the present invention another appearance. The bell time could be set via a keyboard 21. A display panel 20 can show the time and a question. When the alarm clock 2 rings, the display panel 20 will show a question, a sleeper has to key-in the correct answer to stop the bell.

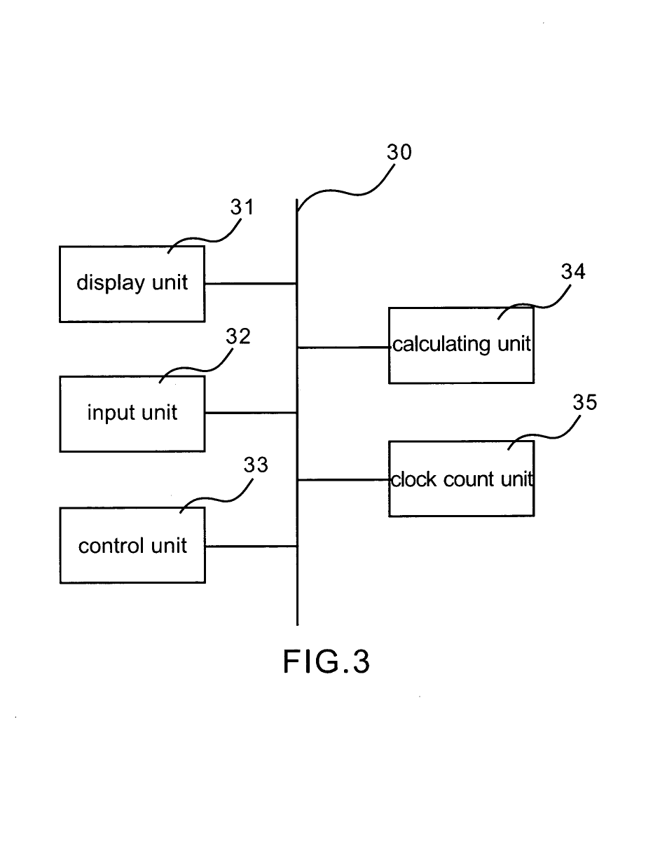

To clearly explicate the technology of the present invention, FIG. 3 shows a circuit structure schematic drawing of the present invention. More detail explanation is as below.

By accessing a control unit 33 and submitting of an interface 30, a calculating unit 34 automatically generates a question at random. The question will be input into a control unit by an input unit 32 and be shown on a display unit 31. When the setting of the bell time (via a clock count unit 35) is up, the display unit 31 shows the question synchronously. The only way to stop the bell ringing is to input the correct answer by the input unit 32.

To sum up, the present invention improves the defect of not awakening the sleeper via the more effective electric circuit structure of a question-and-answer alarm clock. The present invention is superior in function and is never used in publication or mass-production. The present invention is fully complied with three factors of a patent, novelty, progress and the industry may use.

The invention being thus described, it will be obvious that the same way be varied in many ways. Such Variations are not to be regarded as a departure from the spirit and scope of the invention, and all such modifications as would be obvious to one skilled in the art are intended to be included within the scope of the following claims.

What is claimed is:

1. An electric circuit structure of a question-and-answer alarm clock, including:
an interface, which is to be used as a transmitting interface for each unit;
a display unit, which is to be electrically interlocked onto the interface to show time and a question;
an input unit, which is to be electrically interlocked onto the interface, putting data in through an input device and showing the result via the display unit;
a clock count unit which is to be electrically interlocked onto the interface and used to count the time, set the bell, and show the result by the display unit;
a calculating unit which is to be electrically interlocked onto the interface and automatically generates a question when the bell rings, and shows question by the display unit; and
a control unit, which is to be electrically interlocked onto the interface to access each unit that

2. The electric circuit structure as claimed in claim 1, wherein the display unit is an LCD screen to show time and the question.

3. The electric circuit structure as claimed in claim 1, wherein the display unit is an LED screen to show time and the question.

4. The electric circuit structure as claimed in claim 1, wherein the input device can be a keyboard
